(19) United States
(12) Patent Application Publication
(10) Pub. No.: US 2012/0095692 A1
(43) Pub. Date: Apr. 19, 2012

(54) METHOD FOR COMBINING SUB-THERAPEUTIC DOSES

(76) Inventor: W. Matthew Warnock, Salt Lake City, UT (US)

(21) Appl. No.: 13/086,302

(22) Filed: Apr. 13, 2011

Related U.S. Application Data
(63) Continuation-in-part of application No. 11/952,866, filed on Dec. 7, 2007, now abandoned.
(60) Provisional application No. 60/874,739, filed on Dec. 14, 2006.

(51) Int. Cl. G06F 19/00

(52) U.S. Cl. 702/19

(57) ABSTRACT

A method is disclosed for selecting ingredient subsets for evaluation. The method receives a selection of at least one primary clinical effect and selects a plurality of ingredients that have the at least one primary clinical effect. In addition, the method scores for each ingredient a strength of the at least one primary clinical effect and each secondary clinical effect for an average therapeutic dose normalized to body mass for each of a group of subjects. The method further selects for evaluation each subset of the plurality of ingredients satisfying the equation

$$\frac{{\sum }_{i = 1}^{n} {e}_{iP}}{n} > {T}_{p}$$

for each primary clinical effect and

$$\frac{{\sum }_{i = 1}^{n} {e}_{iS}}{n} < {T}_{s}$$

for each secondary clinical effect, wherein n is a number of ingredients, i indicates an ith ingredient, e_{iP} is a strength of the primary clinical effect of ingredient Aᵢ, Tₚ is a specified primary effect threshold, e_{iS} is a strength of a specified secondary clinical effect of the ingredient Aᵢ, and Tₛ is a specified secondary effect threshold.

### CROSS-REFERENCES TO RELATED APPLICATIONS

This application claims priority to U.S. patent application Ser. No. 11/952,866 entitled “METHOD AND APPARATUS FOR COMBINING SUB-THERAPEUTIC DOSES” and filed on Dec. 7, 2007 for W. Matthew Warnock which is incorporated herein by reference and claims priority to U.S. Provisional Patent Application No. 60/874,739 entitled “PORTFOLIO METHOD FOR FORMULATING NEW MEDICINES BY COMBINING SUB-THERAPEUTIC DOSES OF KNOWN MEDICINES” and filed on Dec. 14, 2006 for W. Matthew Warnock, which is incorporated herein by reference.

### BACKGROUND OF THE INVENTION

1. Field of the Invention

This invention relates to methods for formulating new medicines comprising multiple medicinal ingredients.

2. Description of the Related Art

Medicines are generally dose-dependent. The effect of a medicine is typically a function of the dose administered. A higher dose produces a greater response than a lower dose. Often a significant dose is required before any response is observed. A lesser dose may elicit no measurable response. The dose required in order to elicit a desired response is referred to herein as a therapeutic dose.

A sub-therapeutic dose is a dose that is not expected to elicit the desired therapeutic response. For example, if the therapeutic dose of a medicine is two milligrams per kilogram (2 mg/kg) of body weight, a sub-therapeutic dose may be one milligram per kilogram (1 mg/kg) dose.

Conventional therapeutic doses are determined through statistical analysis of average dose-response curves. However, human bodies are unique, and respond differently to different medicines. Some people respond more or less strongly than the average, making the medicine more or less effective than normal. In addition, almost all medicines have multiple effects, including side effects and possible adverse reactions. These may be stronger in some individuals than in others, but are also often dose-dependent. Since “normal” doses are based on the mean response, there will always be extreme responses, both on the desired or primary effect, and on the undesired secondary or side effects, including allergic and other adverse reactions.

Because all of these adverse reactions are generally dose-dependent, one way to reduce the incidence and severity of these adverse reactions would be to reduce the normal dose. However, this would also reduce the effectiveness of the medicine, which is also dose-dependent. A sub-therapeutic dose is unlikely to cause significant adverse effects, but is also usually an ineffective medicine.

Sub-therapeutic doses from multiple ingredients with a desired effect may be combined to achieve the effect of a therapeutic dose. This approach is common in traditional Chinese and Ayurvedic medicine, with many examples of traditional formulas that are commonly used in formulations and doses which, when considering the separate ingredients comprised in the formula, use doses less that those traditionally recommended for that ingredient alone. Some traditional texts explicitly suggest that a practitioner may use less of a given ingredient in a formula, than would normally be used if that same ingredient were used separately. However, these disciplines provide little if any guidance on how much less of an ingredient can be used in a formula, or why, or how to create new formulas from known or newly discovered ingredients. A formula comprising only two ingredients may have infinite variants between 0% and 100% of a normal therapeutic dose of each ingredient, and the complexity increases exponentially with each additional ingredient. Some traditional formulas may contain as many as 50 ingredients, and there are many possible ingredients that could be considered in new formulations. However, screening all possible combinations of sub-therapeutic doses that may be effective is expensive and time consuming. One purpose of the present invention is to reduce the many possible doses and combinations to a manageable number of likely candidates for testing.

### BRIEF DESCRIPTION OF THE DRAWINGS

In order that the advantages of the invention will be readily understood, a more particular description of the embodiments will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a graph showing dose/response points;

FIG. 2 is a graph showing a linear regression of dose/response points;

FIG. 3 is a graph showing a sigmoid curve model of dose/response points;

FIG. 4 is a graph showing a distribution of subject responses to a dose;

FIG. 5 is a schematic flow chart diagram illustrating one embodiment of a screening method;

FIG. 6 is a schematic flow chart diagram illustrating one embodiment of a ingredient subset selection method;

FIGS. 7A, 7B, and 7C are table diagrams illustrating a relationship of exemplary ingredients;

FIG. 8 is a graph showing combined primary and secondary effects of exemplary ingredients;

FIG. 9 is a graph showing an averaged combined effect of exemplary ingredients;

FIG. 10 is a graph showing a combined primary effect for a ingredient subsets; and

FIG. 11 is a schematic block diagram illustrating one embodiment of a computer.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

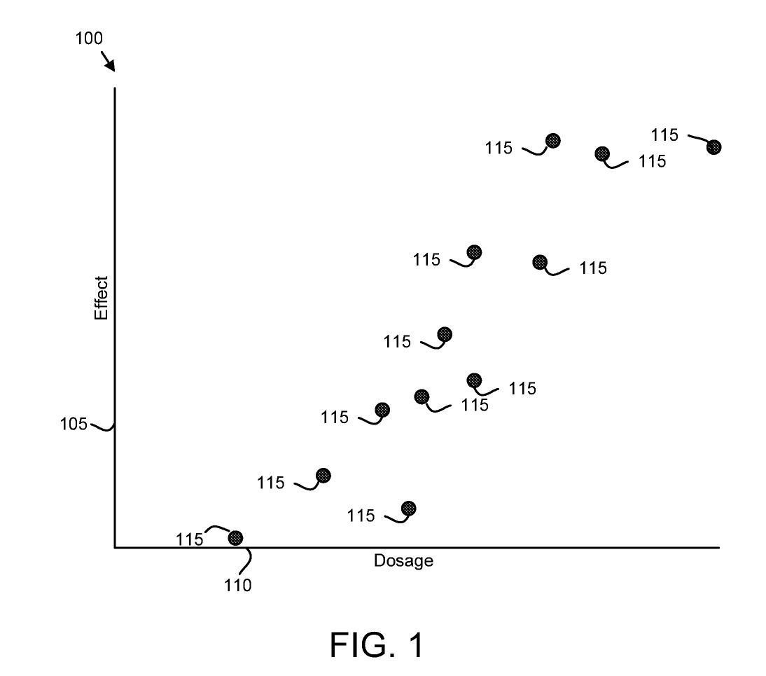

FIG. 1 is a graph 100 showing dose/response points 115. The graph 100 is illustrative of determining a therapeutic dose for specified ingredient. Ingredients may be herbal, animal, mineral, and/or synthetic ingredients. As depicted, the graph 100 plots the effect 105 of an ingredient administered to one or more subjects in a plurality of doses 110 as dose/response points 115.

The effect 105 may be measured as an absolute measure, as observed change, and/or as an effectiveness. For example, the effect 105 may be an absolute measure such as diastolic blood pressure in a subject. In an alternate example, the effect 105 may be observed change such as an observed reduction in pain in the subject. In another example, the effect 105 may be an effectiveness such as observed reduction in diastolic blood pressure as a percentage of the highest observed pressure of the subject.

The ingredient may be administered to a plurality of individuals with a plurality of doses 110. In one embodiment, the ingredient is normalized to the body mass of the individual. For example, a specified dose 110 may be normalized to three grams (3 g) for a man with a mass of seventy-five kilograms (75 kg) and four grams (4 g) for another man with a mass of one hundred kilograms (100 kg).

The graph 100 may be constructed from the results of a clinical trial that is conducted to determine a therapeutic dose for the ingredient. Although for simplicity, a graph 100 is shown with eleven (11) dose/response points 115, a clinical trial may generate any number of dose/response points 115.

Even with the doses 110 normalized to body mass, the reaction of each individual to a dose 110 may vary significantly. Differences in the pharmacokinetics and the pharmacodynamics of an individual and an ingredient result in significant differences in effect.

As a result, the graph 100 is primarily useful in determining an average therapeutic dose for the ingredient. Although for illustrative purposes the data is shown on the graph 100, the data may be used by a computer program product. The computer program product may include a tangible storage device such as a hard disk drive having a computer readable program. The computer readable program may be executed on a computer as is well known to those of skill in the art, causing the computer to process and manipulate the data. The data of the graph 100 may be used to determine a therapeutic dose as will be described hereafter.

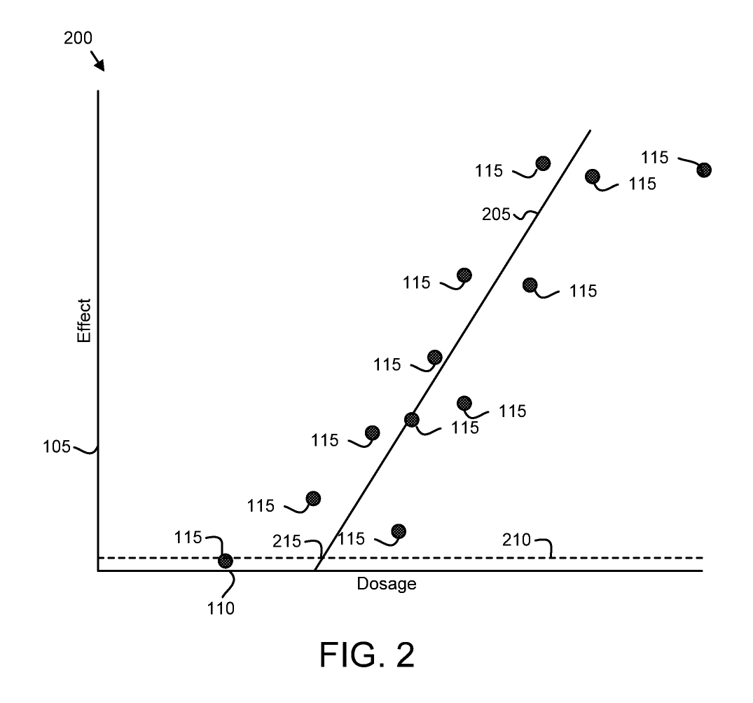

FIG. 2 is a graph 200 showing a linear regression 205 of the dose/response points 115 of FIG. 1. The description of the graph 200 refers to elements of FIG. 1, like numbers referring to like elements. In one embodiment, the linear regression 205 is an expression of the equation y=bx+c where y is the effect 105, x is the dose 110, and b and c are calculated constants. The linear regression 205 may be calculated using a least-squares analysis, polynomial fitting, and trend line regression as is well known to those of skill in the art.

In one embodiment, a minimum effect 210 is established. The minimum effect 210 may be a minimum desired effect. Alternatively, the minimum effect 210 may be an absence of a clinically observed effect 105. In a certain embodiment, the minimum effect 210 is established at a level where fifty percent (50%) of subjects have the desired minimum effect, a measure referred to hereinafter as EC50. Alternatively, the minimum effect 210 is established at a level where eighty percent (80%) of subjects have the desired minimum effect, a measure referred to hereinafter as EC80.

A therapeutic dose 215 may be the dose 110 of the ingredient that results in the minimum desired effect that satisfies EC50. The minimum desired effect may be referred to as effective, therapeutic, clinical, or the like. Alternatively, the therapeutic dose 215 may be the dose 110 of the ingredient that results in the minimum desired effect satisfying EC80

The therapeutic dose 215 may be calculated as the dose 110 that yields the minimum effect 210 when applied to the linear regression equation. In one example, the linear regression equation is Equation 1, where the therapeutic dose 215 x is measured in milligrams, and the minimum effect is a numerical value y, and h is a constant.

y=gx+h Equation 1

In one embodiment, the computer program product calculates the linear regression 205 of the dose/response points 115. In addition, the computer program product may calculate the therapeutic dose 215 from a specified minimum effect 210.

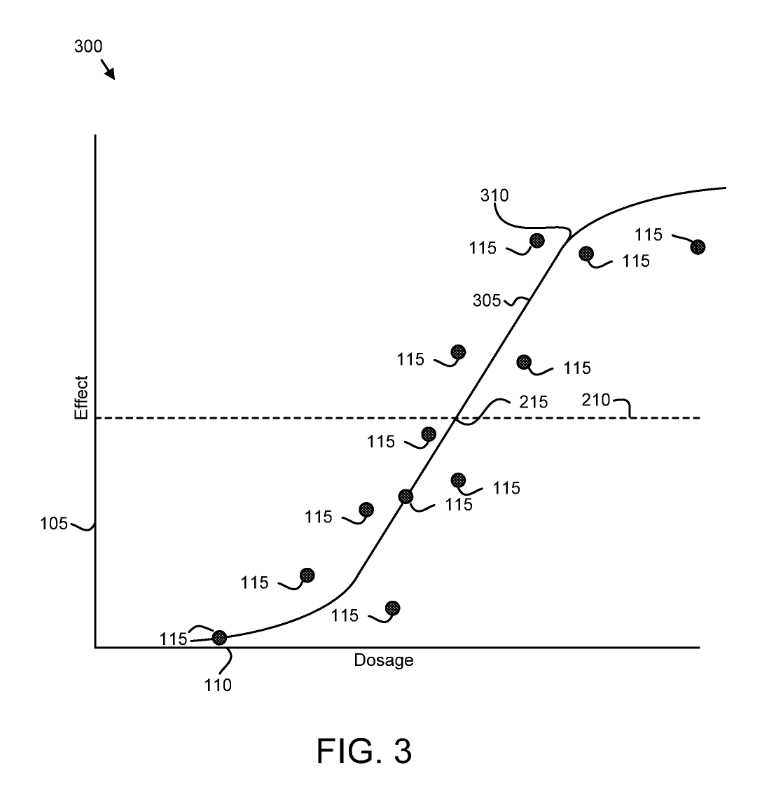

FIG. 3 is a graph 300 showing a sigmoid curve model 305 of the dose/response points 115 of FIG. 1. The description of the graph 300 refers to elements of FIGS. 1-2, like numbers referring to like elements. In one embodiment, the sigmoid curve model 305 is an approximation of the dose/response points 115 in the form of Equation 2 where y is the effect 105, x is the dose 110, and b and c are calculated constants.

y=b(1/(1+e^{-x}))+c Equation 2

A computer program product may derive a therapeutic dose 215 from the sigmoid curve model 305. In one embodiment, the therapeutic dose 215 is calculated as the dose 110 that yields the minimum effect 210 when applied to the sigmoid curve model 305. In an alternate embodiment, the therapeutic dose 215 may be selected at the dose 110 at a sigmoid curve model inflexion point 310.

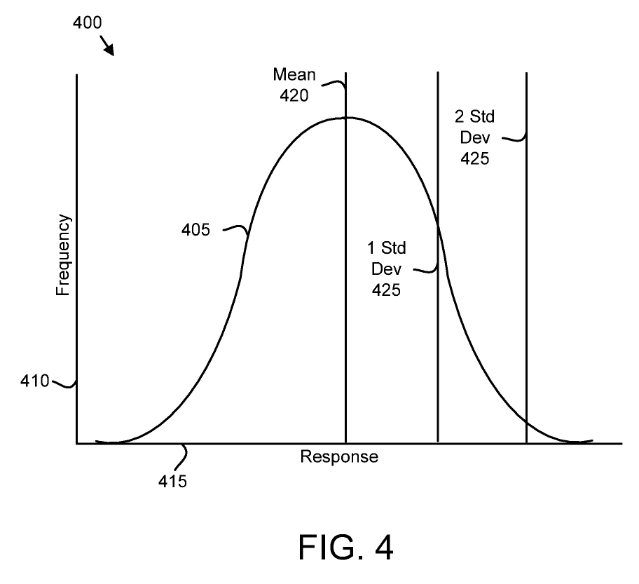

FIG. 4 is a graph 400 showing a distribution of subject responses to a dose of an ingredient. The description of the graph 300 refers to elements of FIGS. 1-3, like numbers referring to like elements. In one embodiment, the graph 400 illustrates a response 415 to a specified dose of the ingredient by a plurality of subjects. The specified dose may be normalized to the body mass of each subject.

The response 415 may be analogous to the effect 105 of FIGS. 1-3. The graph 400 shows a frequency 410 indicative of a number of subjects that have a specified response 415. A bell curve 405 is fitted to the clinical data such as the dose/response points 115 of FIG. 1 as is well known to those of skill in the art. The bell curve 405 yields a mean 420 and first and second standard deviations 425a, 425b for the subject population.

In one embodiment, the computer program product calculates the bell curve 405 from the clinical data. The therapeutic dose 215 for the ingredient may be selected for a specified response 415. For example, the therapeutic dose 215 may be selected at the mean response 420, satisfying the EC50 criteria. Alternatively, the therapeutic dose 215 may be selected for a one standard deviation response 425. In one embodiment, the therapeutic dose 215 is selected where eighty percent (80%) of the subjects have the desired response, satisfying EC80.

An embodiment employs calculations of therapeutic doses for multiple ingredients to combine sub-therapeutic doses of the ingredients as will be described hereafter. One of skill in the art will recognize that the embodiments may use therapeutic doses calculated with other methods.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Given the potential and likelihood of adverse events for a therapeutic dose of any given ingredient, there may be significant advantage to combining multiple ingredients, creating a therapeutic dose from sub-therapeutic doses of several ingredients. Thus sub-therapeutic dose of a plurality of ingredients with a common primary effect may be combined to produce a combined therapeutic dose.

These combined ingredients could be different agonists or antagonists of the same receptors, or agonists or antagonists of different receptors that stimulate a common desired primary effect. The ingredients could combine to create, increase, or potentiate a desired primary effect, while also reducing the unwanted secondary effects that might be likely for each individual ingredient because of the reduced dose of each. However, the range and complexity of possible doses increases exponentially with each additional potential ingredient under consideration.

The embodiments described hereafter screen a plurality of ingredients for combinations of sub-therapeutic doses that may combine to stimulate a desired primary effect. The embodiments may further minimize undesirable secondary effects such as harmful side effects by delivering sub-therapeutic doses of ingredients that do not combine to stimulate a secondary effect. Thus the embodiments screen for combinations of ingredients that may stimulate the primary effect without stimulating secondary effects.

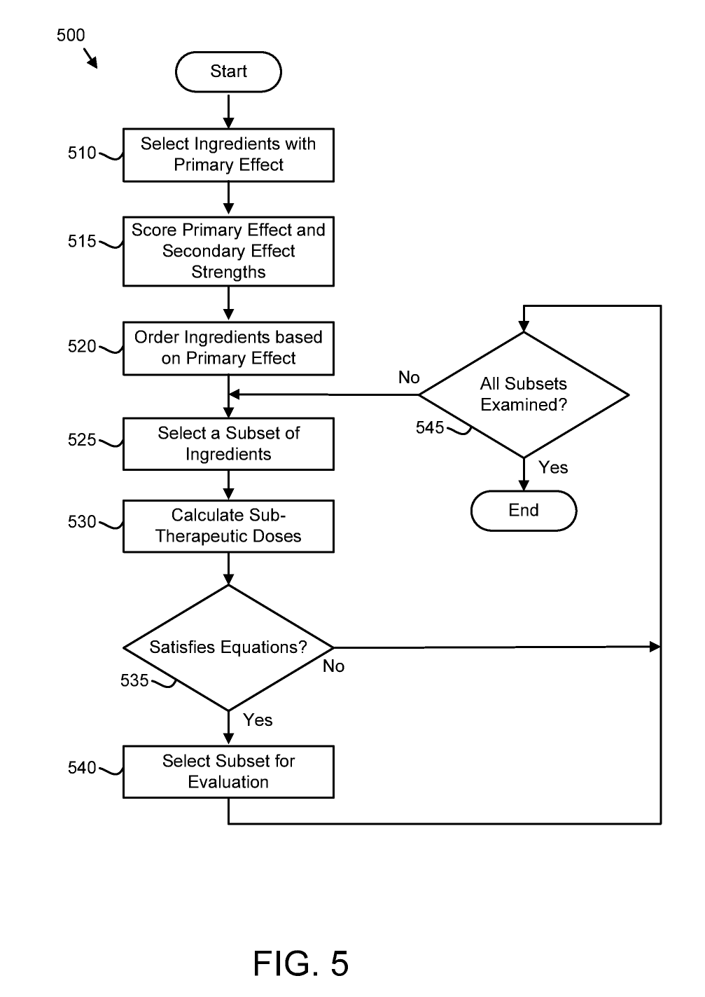

FIG. 5 is a schematic flow chart diagram illustrating one embodiment of a screening method 500. The method 500 may be practiced by computer executing a computer program product. The description of the method 500 refers to elements of FIGS. 1-4, like numbers referring to like elements.

The method 500 starts and the computer program product selects 510 a plurality of ingredients that have a primary effect. In one embodiment, the computer program product consults a database of ingredients and selects 510 each ingredient that has the primary effect.

The primary effect may be a desired subject response. In one embodiment, the primary effect is symptomatic, wherein the symptoms are alleviated. For example, the primary effect may be a reduction in blood pressure. Alternatively, the primary effect may be tonic. A tonic effect strengthens the body of the subject. In one embodiment, the computer program product selects 510 a plurality of ingredients that have one or more symptomatic primary effects and one or more tonic primary effects.

The primary effect may be specified in response to need, such as a need to reduce blood pressure. In an alternate embodiment, the primary effect is the primary effect of a target ingredient, such as an ingredient that is being prepared as commercial product. For example, the primary effect may be a sedative primary effect when devising a formulation for a product comprising chamomile. Although for simplicity, the method 500 will be described for a single primary effect, one of skill in the art will recognize that the invention may be practiced with a selection of any number of primary effects.

The computer program product may score 515 a strength of the primary effect and each secondary effect for a dose of each ingredient. The primary effect and secondary effects may be clinical effects. In one embodiment the dose is the therapeutic dose 215 for a specified result. The computer program product may calculate the therapeutic dose 215 as described in FIGS. 1-4. Alternatively, the computer program product may consult a database of ingredients and retrieve the strength of the primary effect and the strength of each secondary effect for each ingredient. If an ingredient does not have a specified secondary effect, the strength of the secondary effect may be zero (0).

A secondary effect may be an undesirable effect, such as a risk of organ damage. However, secondary effects may also be positive though not necessarily sought for the formulation. An embodiment may mitigate the strength of unwanted secondary effects as will be discussed hereafter.

In one embodiment, the primary and secondary effect strengths are scored 515 using a rate of effect. The rate of effect may be a time interval required for a therapeutic dose 215 of the ingredient to have a desired effect. Alternatively, the primary and secondary effect strengths are scored using a potency. In one embodiment, the potency is a measure of magnitude of the effect.

In a certain embodiment, the primary and secondary effect strengths are scored using a combination of rate of effect and potency. The strength may be calculated using equation 3, where e is the strength, r is the rate of effect, p is the potency, a is a rate scaling factor and b is a potency scaling factor.

e=ar+bp Equation 3

In one embodiment, the computer program product orders 520 ingredients based on the primary effect. For example, the computer program product may order 520 ingredients in descending order from the ingredient with the strongest primary effect. Similarly, the computer program product may order ingredients with equivalent primary effects in descending order from the ingredient with the weakest secondary effect.

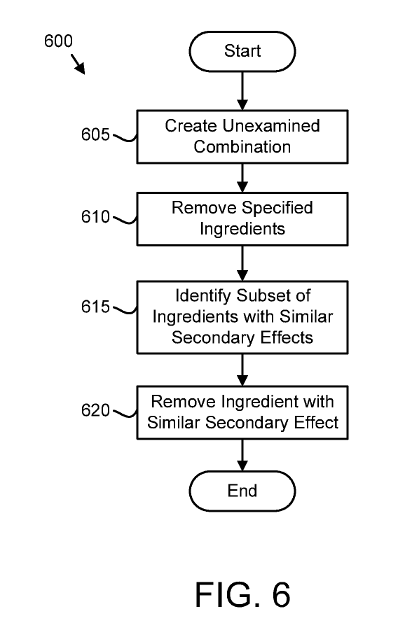

The computer program product selects 525 a subset of the plurality of ingredients. In one embodiment, the computer program product selects 525 a previously unexamined ingredient subset. The ingredient subset may be selected by giving preference to ingredients at the beginning of the order of ingredients. In addition, the computer program product may remove ingredients from the ingredient subset as described hereafter for FIG. 6.

In one embodiment, the computer program product calculates 530 a sub-therapeutic dose of each selected ingredient in the ingredient subset. The sub-therapeutic dose may be calculated using Equation 4 where d, is the sub-therapeutic dose of the ingredient, d_{iT} is the therapeutic dose for the ingredient, and m is the sub-therapeutic divisor. In one embodiment, the sub-therapeutic divisor m is a number of the selected ingredients in the ingredient subset. Alternatively, m may be a number of active compounds within all of the ingredients that have the primary effect. In one embodiment, m is a number in the range of 4 to 10. In addition, k may be a constant in the range of 0.6 to 1.3. In a certain embodiment k is 1. The constant k is not zero (0).

dᵢ=d_{iT}/km Equation 4

Alternatively, the computer program product calculates 530 a sub-therapeutic dose of each selected ingredient in the ingredient subset using Equation 5, where d_{T} is a target therapeutic dose for the ingredient subset.

dᵢ=d_{T}/km Equation 5

The computer program product determines 535 if the combination of ingredients satisfies Equations 6 and 7, where n is a number of the plurality of ingredients, Aᵢ is an ith single ingredient, eₐ, is a strength of the primary effect of ingredient Aᵢ, Tₚ is the specified primary effect threshold, eᵢₛ is a strength of a specified secondary effect of Aᵢ, and Tₛ is the specified secondary effect threshold.

$$\begin{matrix}\frac{{\sum }_{i = 1}^{n} {e}_{iP}}{n} > {T}_{p} & Equation 6 \\ \frac{{\sum }_{i = 1}^{n} {e}_{iS}}{n} < {T}_{s} & Equation 7\end{matrix}$$

In addition, the computer program product may determine if the combination of ingredient satisfies Equation 8, where wᵢ is a mass of a therapeutic dose of each ingredient and Tm is a mass threshold such as 50 mg. The mass threshold may be in the mass of 10 to 75 mg.

$$\frac{{\sum }_{i = 1}^{n} {w}_{i}}{n} < {T}_{m} \qquad Equation 8$$

If the ingredient subset satisfies Equations 6, 7, and 8 the computer program product selects 540 the ingredient subset for evaluation. The computer program product determines 545 if all possible subsets of the plurality of ingredients have been examined. If all subsets of the plurality of ingredients have not been examined, the computer program product selects 535 a new ingredient subset. If all subsets of the plurality of ingredients have been examined, the method 500 ends. If the ingredient subset does not satisfy Equations 6, 7, and 8, the computer program product determines 610 if all possible subsets of the plurality of ingredients have been examined.

The method 500 allows the computer program product to screen a significant number of ingredient combinations and select one or more ingredient subsets for further evaluation. Thus the method 500 rapidly identifies promising combinations of ingredients.

FIG. 6 is a schematic flow chart diagram illustrating one embodiment of an ingredient subset selection method 600 of the present invention. The method 600 may be embodied in step 525 of FIG. 5. The method 600 may be performed by a computer executing a computer program product. The description of the method 600 refers to elements of FIGS. 1-5, like numbers referring to like elements.

The method 600 starts and in one embodiment the computer program product creates 605 the ingredient subset. In one embodiment, the computer program product sequentially creates 605 one of all possible combination of the plurality of ingredients as the ingredient subset. The created ingredient subset may be a previously unexamined combination of ingredients of the possible combinations of the plurality of ingredients.

In one embodiment, the computer program product constructs a multidimensional matrix for each possible combination of ingredients. Alternatively, the computer program product may construct the multidimensional matrix and select two possible combinations of ingredients from the matrix. The computer program product may then evaluate each combination using Equations 6, 7, and 8 and calculate an improvement vector. The improvement vector may indicate changes to the combinations of ingredients that are likely to result in a more favorable combination of ingredients. The computer program product may use the improvement vector to select a third combination of ingredients that satisfies the improvement vector. The computer program product may use the third combination of ingredients to calculate another improvement vector and combination of ingredients, repeating the process until an optimum combination of ingredients is found.

In one embodiment, the computer program product removes 610 specified ingredients from the ingredient subset. The specified ingredients may flagged as too expensive, too difficult to procure, too difficult to prepare, or the like.

In one embodiment, the computer program product identifies 615 a secondary effect group of ingredients with a similar secondary effect. The secondary effect may be a clinical effect. For example, if a first and second ingredient shares a first secondary effect, the computer program product may identify 525 a secondary effect group comprising the first and second ingredient.

The computer program product may remove 620 at least one ingredient of the secondary effect group from the ingredient subset and the method 600 ends. Continuing the example above, the computer program product may remove 620 the first ingredient from the ingredient subset. In one embodiment, only one ingredient of the secondary effect group is not removed.

In one embodiment, the computer program product does not remove 620 at least one ingredient that mutually potentiates another ingredient. For example, a first ingredient may not be removed for increasing the primary effect strength of a third ingredient.

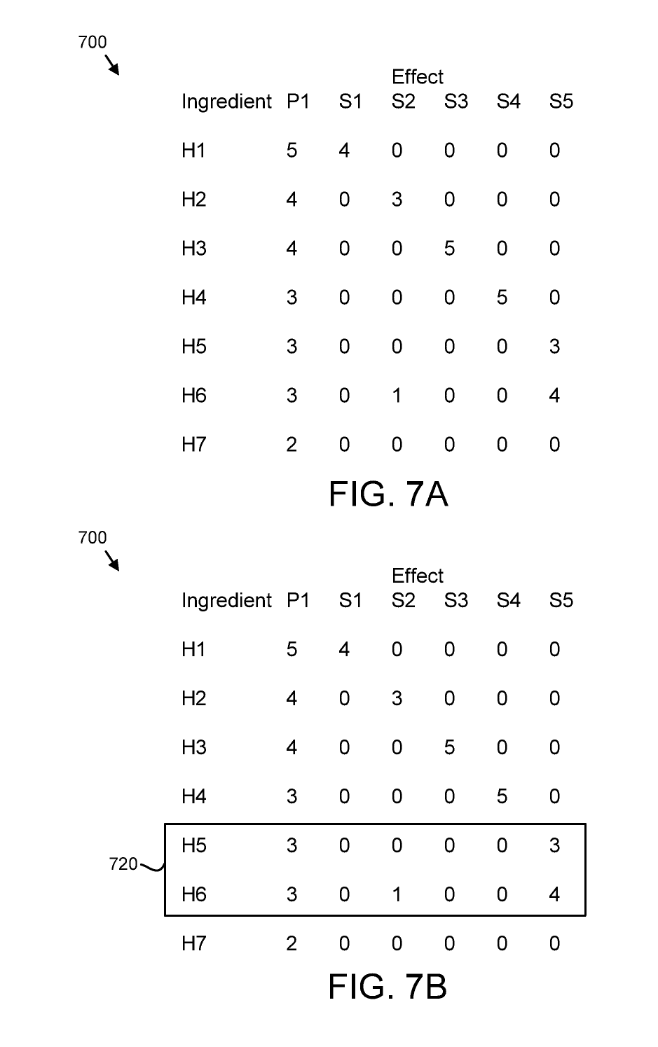

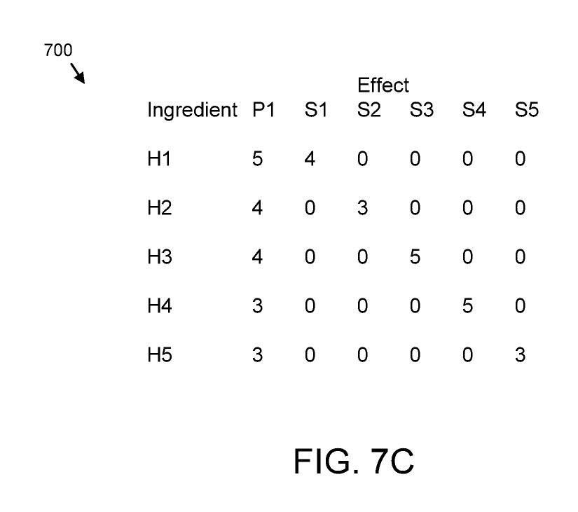

FIGS. 7A, 7B, and 7C are table diagrams 700 illustrating a relationship of exemplary ingredients of the present invention. The description of the diagrams 700 refers to elements of FIGS. 1-6, like numbers referring to like elements, is illustrative of the methods 500, 600 of FIGS. 5 and 6.

In FIG. 7A, a plurality of exemplary ingredients H1-7 are listed. The practitioner and/or computer program product may select 510 the ingredients H1-7 because of a primary effect. In the diagrams 700, each of the ingredients H1-7 has the primary effect P1.

The ingredients H1-7 also have a plurality of secondary effects S1-5. Each of the secondary effects S1-5 of the ingredients H1-7 is listed in the diagram 700. The practitioner and/or computer program product may score 515 the strength of the primary effect P1 and each secondary effect S1-5 for each ingredient H1-7. In addition, the practitioner and/or computer program product may order 520 the ingredients H1-7 based on the primary effect P1. The ingredients H1-7 are shown ordered from greatest primary effect to least primary effect.

In FIG. 7B, the practitioner and/or computer program product identifies 525 a secondary effect subset 720 of ingredients in the diagram 700 with a similar secondary effect S5. As shown, ingredients H5 and H6 are identified 525 as belonging to the secondary effect subset 720.

The practitioner and/or computer program product may remove 530 at least one ingredient of the subset of ingredients from the diagram. For example, the computer program product may remove 530 ingredient H6 as shown in FIG. 7C.

The practitioner and/or computer program product selects 535 a subset of the plurality of ingredients where the average of the primary effect strengths of the selected ingredients exceeds the specified primary effect threshold. For example, if the primary effect threshold is three point six (3.6), the combination of ingredients H1, H2, H3, H4, H5, and H7 has an average primary effect of three point five (3.5) and does not exceed the primary threshold. However, the combination of ingredients H1, H2, H3, H4, and H5 has an average primary effect of three point eight (3.8) and does exceed the primary threshold. Therefore FIG. 7C is shown with selected subset of ingredients H1, H2, H3, H4, and H5.

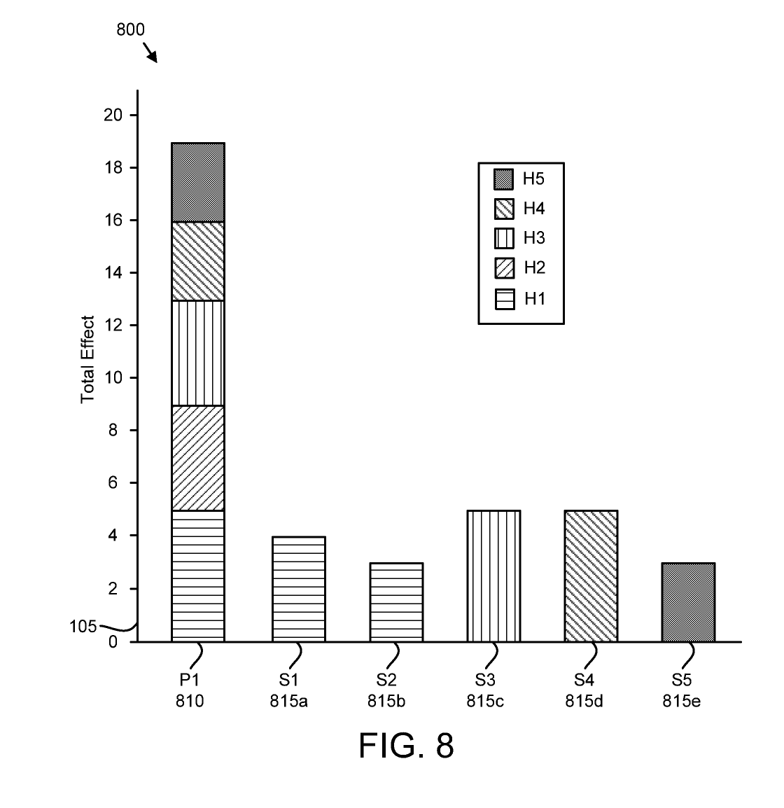

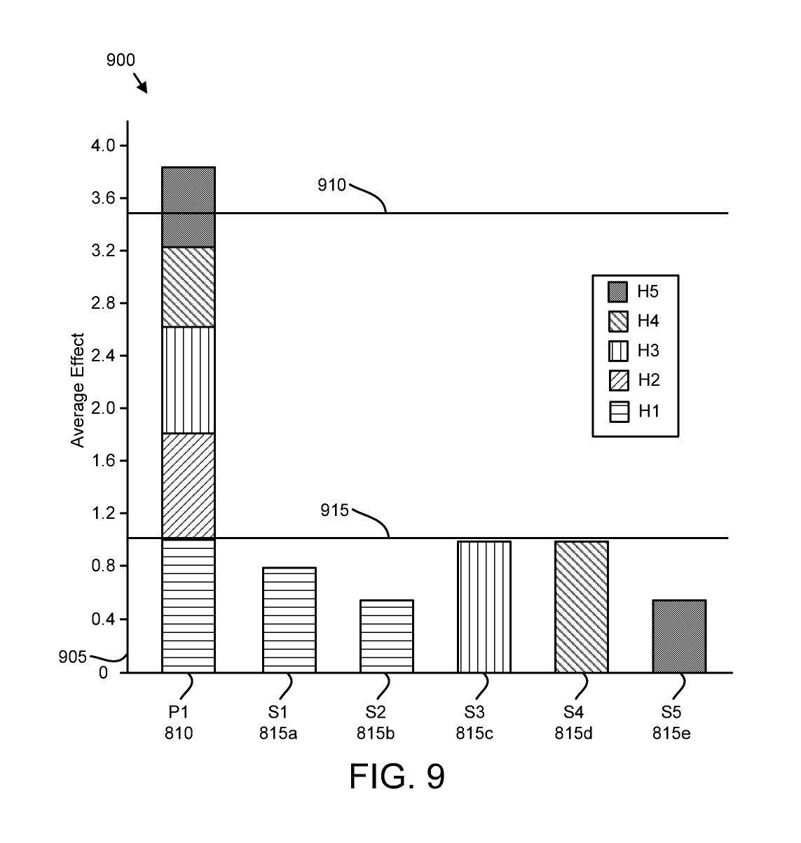

FIG. 8 is a graph 800 showing combined primary and secondary effects of exemplary selected ingredients H1-5 of FIG. 7C. The effects 105 of the primary effect 810 and the secondary effects 815 for the selected ingredients H1-5 are shown along a vertical axis.

Because the primary effect 810 of the selected ingredients H1-5 is additive, the primary effect 810 of the combine selected ingredients H1-5 is significantly greater than any of the secondary effects 815. Thus the combination of the selected ingredients H1-5 provides the primary effect 810 while mitigating the secondary effects 815.

FIG. 9 is a graph showing a combined effect of exemplary ingredients comprising the ingredients H1-5 of FIG. 8. The value of the combined effect 905 of the primary effect 810 and the secondary effects 815 for the ingredients H1-5 are shown along a vertical axis. A primary effect threshold 910 and a secondary effect threshold 915 are also shown. The ingredient subset of H1-5 satisfies the Equations 6 and 7 and so is selected for further evaluation.

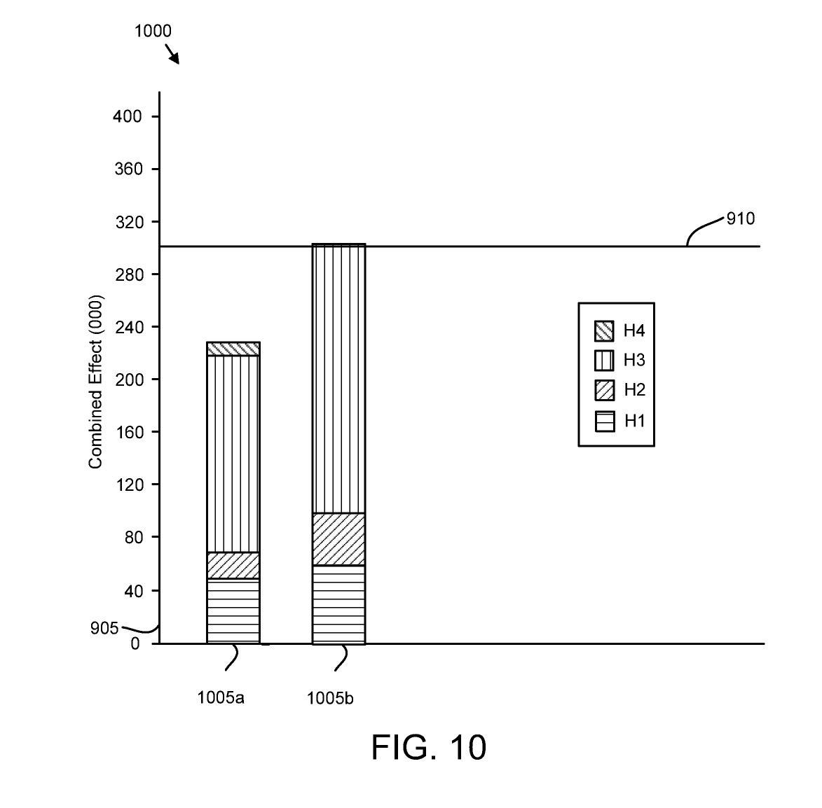

FIG. 10 is a graph 1000 showing a combined primary effect for an exemplary first ingredient subset 1005a and a second ingredient subset 1005b selected for Transient Receptor Potential cation channel subfamily V member 1 (TRPV1) activation. The selected first ingredient subset 1005a comprises first ingredients Zingiber officinale H1, Piper nigrum H2, Capsicum annuum H3, and Xanthoxylum piperitum H4. The selected second ingredient subset 1005b comprises second ingredients Zingiber officinale H1, Piper nigrum H2, and Capsicum annuum H3. The description of the graph 1000 refers to elements of FIGS. 1-9, like numbers referring to like elements.

The first and second ingredients may be selected for the primary effect of milligrams of Scofield Heat Units (SHU) or SHU mg, wherein SHU is a metric of TRPV1 activation. Each ingredient may include one or more active ingredient with the primary effect. Table 1 lists the first and second ingredients, each active compound of each ingredient, the adjusted SHU for each active compound, a pure SHU potency, a percent of the ingredient that is active, an adjusted SHU potency equal to the Pure SHU multiplied by the percent active, and a secondary effect.

TABLE 1

| | | | | Ad- | Sec- |
|---|---|---|---|---|---|
| | Active | | Percent | justed | ondary |
| Botanical name | Compound | SHU Pure | Active | SHU | Effect |
| Zingiber officinale | 6-gingerol | 60,000 | 6% | 3,600 | |
| | 6-shogaol | 160,000 | 6% | 9,600 | |
| | Total | | | 13,200 | Settles |
| | | | | | Stomachs |
| Piper nigrum | piperine | 100,000 | 7.15% | 7,150 | Reduce |
| | | | | | drug |
| | | | | | effects |
| Capsicum annuum | capsaicin | 16,000,000 | 0.25% | 40,000 | Burning |
| Xanthoxylum | α-sanshool | 80,000 | 0.45% | 368 | |
| piperitum | | | | | |
| | β-sanshool | 70,000 | 0.07% | 49 | |
| | γ-sanshool | 110,000 | 0.19% | 209 | |
| | δ-sanshool | 110,000 | 0.02% | 22 | |
| | α-hydroxy- | 26,000 | 2.38% | 619 | |
| | sanshool | | | | |
| | β-hydroxy- | 13,000 | 0.27% | 35 | |
| | sanshool | | | | |
| | Total | | | 1,302 | Numbing |
| | | | | | Effect |

The Zingiber officinale is shown with a side effect of settling stomachs, the Piper nigrum with a side effect of reducing drug effects, Capsicum annuum with a side effect of causing burning, and the Xanthoxylum piperitum with the side effect of causing numbing. Because each ingredient has a different secondary effect, the combined ingredients do not increase any one secondary effect.

The target therapeutic dose d_{T} for the ingredient subset 1005a is 300,000 SHU mg. In Table 2, the therapeutic dose d_{iT} in SHU mg for each ingredient is the first ingredient subset 1005a is shown, along with a sub-therapeutic SHU mg dose dᵢ is calculated for each first ingredient using Equation 4, where k=1 and m=4, the number of active compounds.

TABLE 2

| | | Sub- |
|---|---|---|
| | | therapeutic |
| | Therapeutic | Dose dᵢ |
| | Dose d_{iT} | (SHU mg) |
| Botanical name | (SHU mg) | m = 4 |
| Zingiber officinale | 198,000 | 49,500 |
| Piper nigrum | 107,250 | 26,813 |
| Capsicum annuum | 600,000 | 150,000 |
| Xanthoxylum | 19,528 | 4,882 |
| piperitum | | |
| Total | | 231,194 |

The graph 1000 shows the combined primary effect for the first ingredient subset 1005a. The first ingredient subset 1005a has a combined primary effect less than the primary effect threshold 910 of 300,000 SHU mg.

In Table 3, the therapeutic dose d_{iT} for each ingredient in the second ingredient subset 1005b is shown, along with a sub-therapeutic SHU mg dose dᵢ is calculated for each first ingredient using Equation 4, where k=1 and m=3, the number of active compounds.

TABLE 3

| | | Sub- |
|---|---|---|
| | | therapeutic |
| | Therapeutic | Dose dᵢ |
| Botanical name | Dose d_{iT} | m = 4 |
| Zingiber officinale | 198,000 | 66,000 |
| Piper nigrum | 107,250 | 35,750 |
| Capsicum annuum | 600,000 | 200,000 |
| Total | | 301,750 |

The graph 1000 shows the combined primary effect for the second ingredient subset 1005b. The second ingredient subset 1005b has a combined primary effect greater than the primary effect threshold 910 of 300,000 SHU mg. Thus using the screen method 500, the second ingredient subset 1005b is selected 540 for evaluation while the first ingredient subset 1005a is not selected.

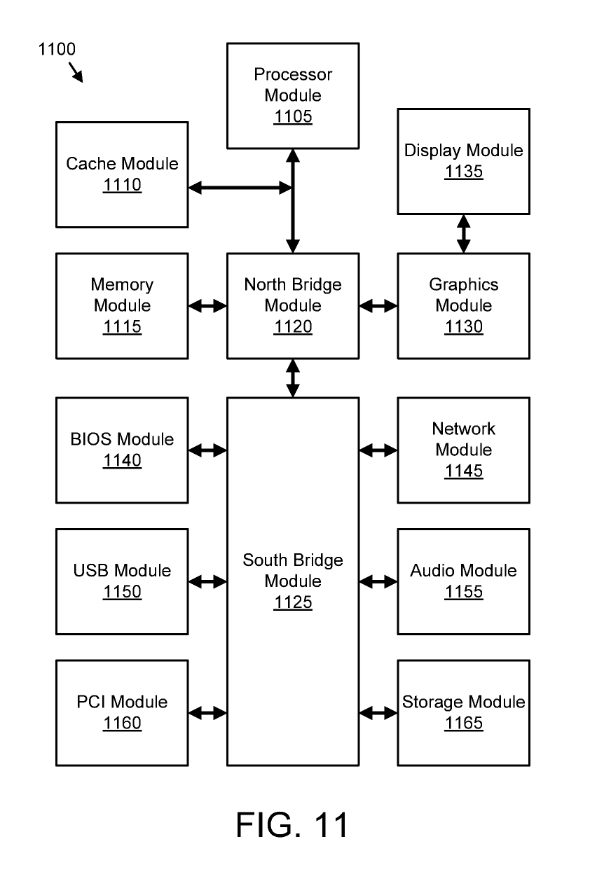

FIG. 11 is a schematic block diagram illustrating one embodiment of a computer 1100 in accordance with the present invention. The computer 1100 includes a processor module 1105, a cache module 1110, a memory module 1115, a north bridge module 1120, a south bridge module 1125, a graphics module 1130, a display module 1135, a basic input/output system (“BIOS”) module 1140, a network module 1145, a Universal Serial Bus (USB) module 1150, an audio module 1155, a peripheral component interconnect (“PCI”) module 1160, and a storage device 1165.

The processor module 1105, cache module 1110, memory module 1115, north bridge module 1120, south bridge module 1125, graphics module 1130, display module 1135, BIOS module 1140, network module 1145, USB module 1150, audio module 1155, PCI module 1160, and storage device 1165, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The memory module 1115 stores software instructions and data. The processor module 1105 executes the software instructions and manipulates the data as is well known to those skilled in the art. The software instructions and data may be configured as one or more computer readable programs. The computer readable programs may comprise a computer program product and be tangibly stored in the storage device 1165. The storage device 1165 may be a hard disk drive, an optical storage device, a holographic storage device, a micromechanical storage device, a semiconductor storage device, or the like. In one embodiment, the computer 1100 executes one or more computer program products that carry out the methods 500, 600 of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for selecting ingredient subsets for evaluation, the method comprising, by use of a computer:
receiving a selection of at least one primary clinical effect;
selecting a plurality of ingredients that have the at least one primary clinical effect;
scoring for each ingredient a strength of the at least one primary clinical effect and each secondary clinical effect for an average therapeutic dose normalized to body mass for each of a group of subjects;
selecting for evaluation each subset of the plurality of ingredients satisfying the equation
$$\frac{{\sum }_{i = 1}^{n} {e}_{iP}}{n} > {T}_{p}$$
for each primary clinical effect and
$$\frac{{\sum }_{i = 1}^{n} {e}_{iS}}{n} < {T}_{s}$$
for each secondary clinical effect, wherein n is a number of ingredients, i indicates an ith ingredient, e_{iP} is a strength of the primary clinical effect of ingredient Aᵢ, Tₚ is a specified primary effect threshold, e_{iS} is a strength of a specified secondary clinical effect of the ingredient Aᵢ, and Tₛ is a specified secondary effect threshold.

2. The method of claim 1, the method further comprising:
identifying a secondary effect group of the plurality of ingredients with a similar secondary clinical effect; and
removing at least one ingredient of the secondary effect group from the plurality of ingredients.

3. The method of claim 2, wherein only one ingredient of the secondary effect group is not removed.

4. The method of claim 1, wherein primary and secondary clinical effect strengths are scored using a rate of effect.

5. The method of claim 1, wherein primary and secondary clinical effect strengths are scored using a potency.

6. The method of claim 1, wherein primary and secondary clinical effect strengths are scored using a sum of a potency multiplied by a potency scaling factor and a rate of effect multiplied by a rate scaling factor.

7. The method of claim 1, wherein the at least one primary clinical effect is symptomatic.

8. The method of claim 1, wherein the at least one primary clinical effect is tonic.

9. The method of claim 1, wherein a plurality of the primary clinical effects comprise at least one symptomatic effect and at least one tonic effect.

10. The method of claim 1, wherein at least one ingredient mutually potentiates at least one other ingredient.

11. A computer program product for selecting ingredient subsets for evaluation comprising a computer readable program executed by a computer to perform the operations of:
receiving a selection of at least one primary clinical effect;
selecting a plurality of ingredients that have the at least one primary clinical effect;
scoring for each ingredient a strength of the at least one primary clinical effect and each secondary clinical effect for an average therapeutic dose normalized to body mass for each of a group of subjects;
selecting for evaluation each subset of the plurality of ingredients satisfying the equation
$$\frac{{\sum }_{i = 1}^{n} {e}_{iP}}{n} > {T}_{p}$$
for each primary clinical effect and
$$\frac{{\sum }_{i = 1}^{n} {e}_{iS}}{n} < {T}_{s}$$
for each secondary clinical effect, wherein n is a number of ingredients, i indicates an ith ingredient, e_{iP} is a strength of the primary clinical effect of ingredient Aᵢ, Tₚ is a specified primary effect threshold, e_{iS} is a strength of a specified secondary clinical effect of the ingredient Aᵢ, and Tₛ is a specified secondary effect threshold.

12. The computer program product of claim 11, the operations further comprising:
identifying a secondary effect group of the plurality of ingredients with a similar secondary clinical effect; and
removing at least one ingredient of the secondary effect group from the plurality of ingredients.

13. The computer program product of claim 12, wherein only one ingredient of the secondary effect group is not removed.

14. The computer program product of claim 11, wherein primary and secondary clinical effect strengths are scored using a rate of effect.

15. The computer program product of claim 11, wherein primary and secondary clinical effect strengths are scored using a potency.

16. The computer program product of claim 11, wherein primary and secondary clinical effect strengths are scored using a sum of a potency multiplied by a potency scaling factor and a rate of effect multiplied by a rate scaling factor.

17. The computer program product of claim 11, wherein the at least one primary clinical effect is symptomatic.

18. The computer program product of claim 11, wherein the at least one primary clinical effect is tonic.

19. The computer program product of claim 11, wherein a plurality of the primary clinical effects comprise at least one symptomatic effect and at least one tonic effect.

20. The computer program product of claim 11, wherein at least one ingredient mutually potentiates at least one other ingredient.
